(19) United States
(12) Patent Application Publication
(10) Pub. No.: US 2014/0191998 A1
(43) Pub. Date: Jul. 10, 2014

(54) NON-CONTACT CONTROL METHOD OF ELECTRONIC APPARATUS

(71) Applicant: EMINENT ELECTRONIC TECHNOLOGY CORP. LTD., Hsinchu (TW)

(72) Inventors: Cheng-Ta Chuang, New Taipei City (TW); De-Cheng Pan, Changhua County (TW); Chih-Jen Fang, Tainan City (TW)

(73) Assignee: EMINENT ELECTRONIC TECHNOLOGY CORP. LTD., Hsinchu (TW)

(21) Appl. No.: 14/148,739

(22) Filed: Jan. 7, 2014

Related U.S. Application Data
(60) Provisional application No. 61/749,398, filed on Jan. 7, 2013.

(30) Foreign Application Priority Data
Jan. 3, 2014 (TW) 103100268

(51) Int. Cl. G06F 3/01

(52) U.S. Cl. CPC G06F 3/017
USPC 345/173; 345/156

(57) ABSTRACT

A control method of an electronic apparatus includes the following steps: generating a plurality of detection signals to a non-contact object around the electronic apparatus; receiving a plurality of reflected signals reflected from the non-contact object in response to the detection signals, and accordingly generating a plurality of detection results; performing arithmetic operations upon the detection results to calculate motion information of the non-contact object around the electronic apparatus; recognizing a non-contact gesture corresponding to the non-contact object according to the motion information; and enabling the electronic apparatus to perform a specific function according to the non-contact gesture.

### CROSS REFERENCE TO RELATED APPLICATIONS

This application claims the benefit of U.S. provisional application No. 61/749,398, filed on Jan. 7, 2013, the contents of which are incorporated herein by reference.

### BACKGROUND OF THE INVENTION

1. Field of the Invention

The disclosed embodiments of the present invention relate to a non-contact control mechanism, and more particularly, to a method for controlling an electronic apparatus according to a position of an object untouching the electronic apparatus in space.

2. Description of the Prior Art

A touch-based electronic apparatus provides a user with intuitive and user-friendly interaction. However, it is inconvenient for the user to control the electronic apparatus when the user holds other objects in a user's hand (e.g. documents or drinks) or the user's hand is oily. For example, while eating french fries and reading an electronic book displayed on a screen of a tablet computer, the user prefers to turn pages of the electronic book without touching the screen using oily fingers.

Thus, a novel touch mechanism is needed to solve the aforementioned problems.

### SUMMARY OF THE INVENTION

It is therefore one objective of the present invention to provide a method for controlling an electronic apparatus according to a position of an object untouching the electronic apparatus in space.

According to an embodiment of the present invention, an exemplary control method of an electronic apparatus is disclosed. The exemplary control method comprises the following steps: generating a plurality of detection signals to a non-contact object around the electronic apparatus; receiving a plurality of reflected signals reflected from the non-contact object in response to the detection signals, and accordingly generating a plurality of detection results; performing arithmetic operations upon the detection results to calculate motion information of the non-contact object around the electronic apparatus; recognizing a non-contact gesture corresponding to the non-contact object according to the motion information; and enabling the electronic apparatus to perform a specific function according to the non-contact gesture.

The proposed control method of an electronic apparatus provides non-contact human-computer interaction to facilitate control of the electronic apparatus. The proposed non-contact control mechanism and touch control may be employed together to realize flexible and intuitive control.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic apparatus capable of detecting a position of a nearby non-contact object according to an embodiment of the present invention.

FIG. 2 is a flow chart of an exemplary control method of an electronic apparatus according to an embodiment of the present invention.

FIG. 3 is a first implementation of a non-contact control of the electronic apparatus shown in FIG. 1 to perform a specific function.

FIG. 4 is a diagram illustrating a relationship between a position of a non-contact object and time involved in a non-contact single tap gesture according to an embodiment of the present invention.

FIG. 5 is a second implementation of a non-contact control of the electronic apparatus shown in FIG. 1 to perform a specific function.

FIG. 6 is a third implementation of a non-contact control of the electronic apparatus shown in FIG. 1 to perform a specific function.

FIG. 7 is a fourth implementation of a non-contact control of the electronic apparatus shown in FIG. 1 to perform a specific function

FIG. 8 is a diagram illustrating a relationship between a position of a non-contact object and time involved in a non-contact double tap gesture according to an embodiment of the present invention.

FIG. 9 is a fifth implementation of a non-contact control of the electronic apparatus 100 shown in FIG. 1 to perform a specific function.

FIG. 10 is a diagram illustrating a relationship between a position of a non-contact object and time involved in a non-contact drag gesture according to an embodiment of the present invention.

### DETAILED DESCRIPTION

In order to provide non-contact human-computer interaction, an electronic apparatus capable of determining motion information of a floating/hovering object (e.g. position and time information associated with the hovering object), and a hovering gesture (or an air gesture; i.e. a non-contact gesture which does not touch the electronic apparatus) defined according to the motion information of the hovering object are utilized to realize a non-contact and intuitive control mechanism. In the following, the proposed non-contact and intuitive control mechanism is described with reference to an electronic apparatus which obtains motion information according to reflected signals reflected from a hovering object. However, this is for illustrative purposes only. Any electronic apparatus capable of determining motion information of a hovering object maybe used to realize the proposed non-contact and intuitive control mechanism.

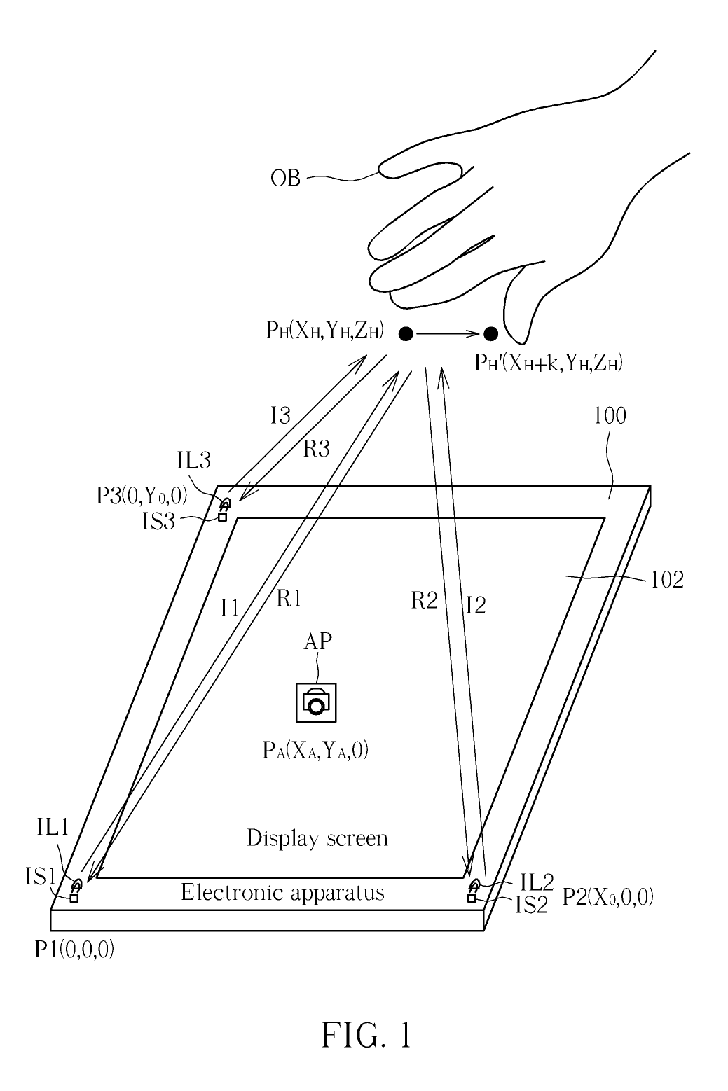

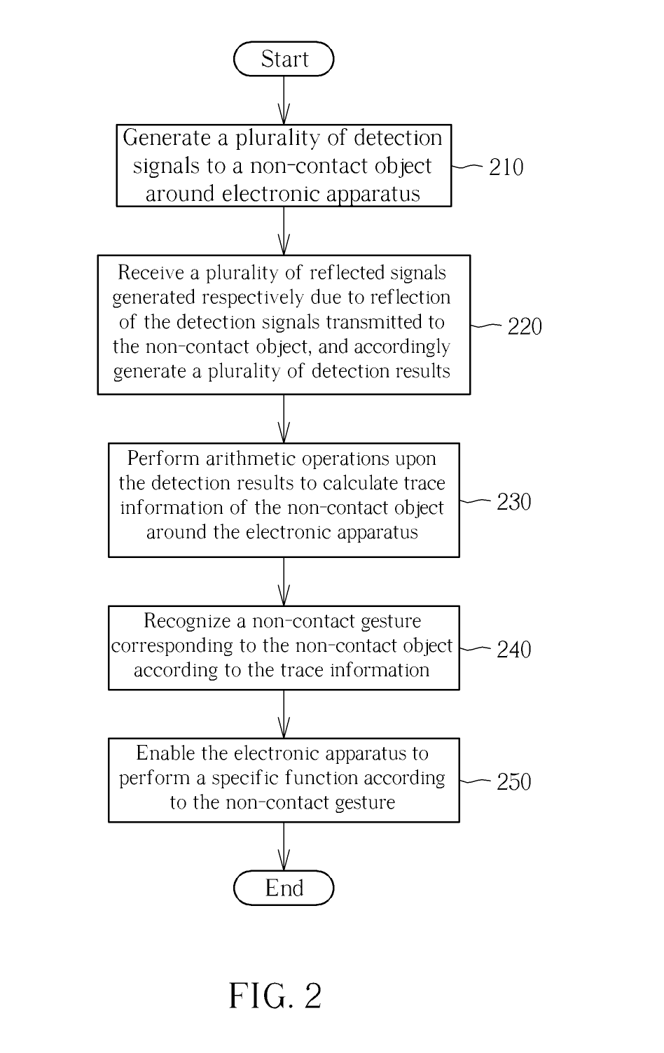

Please refer to FIG. 1 and FIG. 2 together. FIG. 1 is a diagram illustrating an electronic apparatus capable of detecting a position of a nearby non-contact object according to an embodiment of the present invention. FIG. 2 is a flow chart of an exemplary control method of an electronic apparatus according to an embodiment of the present invention, wherein the exemplary method shown in FIG. 2 may be employed in the electronic apparatus 100 shown in FIG. 1. By way of example, but not limitation, the electronic apparatus 100 may be implemented by a portable apparatus (e.g. a smart phone or a tablet computer). The electronic apparatus 100 may include a display screen 102, a plurality of light emitting devices (implemented by a plurality of infrared light-emitting diodes (IR LEDs) IL1-IL3 in this embodiment), a plurality of sensing devices (implemented by a plurality of infrared light sensors (IR sensors) IS1-IS3 in this embodiment) and a processing unit (not shown in FIG. 1).

In steps 210 and 220, each IR LED may be used to generate a detection signal (i.e. emitting an infrared (IR) light signal) to a non-contact object around the electronic apparatus 100. In this embodiment, the non-contact object may be represented by a user's finger OB. Each IR sensor may be used to receive a reflected signal reflected from the user's finger OB in response to the detection signal, and accordingly generate a detection result to the processing unit in order to obtain motion information of the user's finger OB.

To illustrate the obtainment of the motion information of the user's finger OB, the electronic apparatus 100 may define a predefined space coordinate system in the surroundings thereof in this embodiment, wherein the predefined space coordinate system may include a reference surface (i.e. the display screen 102) defined by the IR sensors IS1-IS3. In addition, the IR LEDs IL1-IL3 may be disposed adjacent to the IR sensors IS1-IS3, respectively. Hence, the IR LED IL1 and the IR sensor S1 may be regarded as being located at the same position P1(0, 0, 0), the IR LED IL2 and the IR sensor S21 may be regarded as being located at the same position P2 (X₀, 0, 0), and the IR LED IL3 and the IR sensor S3 may be regarded as being located at the same position P3 (0, Y₀, 0).

The IR LEDs IL1-IL3 may be activated alternately, wherein only one IR LED is activated in a period of time. During one IR LED is activated, a corresponding adjacent IR sensor may be activated to receive a reflected signal reflected from the user's finger OB; when the IR LED is deactivated, the corresponding adjacent IR sensor may be deactivated, thus ensuring that the reflected signal received by the corresponding adjacent IR sensor corresponds to the IR LED. For example, the IR LED L1 may emit an IR light signal I1 to the finger OB, and the IR sensor S1 may receive a reflected signal R1 reflected from the finger OB in response to the IR light signal I1, and accordingly generate a first detection result (e.g. a current signal). Similarly, the IR sensor S2 may receive a reflected signal R2 reflected from the finger OB in response to an IR light signal I2, and accordingly generate a second detection result (e.g. a current signal), and the IR sensor S3 may receive a reflected signal R3 reflected from the finger OB in response to an IR light signal I3, and accordingly generate a third detection result (e.g. a current signal).

In step 230, the processing unit of the electronic apparatus 100 may perform arithmetic operations upon the first, second and third detection results to calculate motion information of the finger OB around the electronic apparatus 100. For example, the processing unit may obtain respective reflected energies of the reflected signals R1-R3 according to the first, second and third detection results, and obtain distances between each IR sensor and the finger OB according to a relationship between a reflected energy and an energy transmission distance. Next, the processing unit may perform the arithmetic operations upon the obtained detection results according to a position of each IR sensor (or a position of each IR LED) and the distances between each IR sensor and the finger OB, thereby calculating a plurality of coordinates (e.g. a position P_{H} (X_{H}, Y_{H}, Z_{H}) shown in FIG. 1) of the finger OB in the predefined space coordinate system, wherein the coordinates correspond to different points in time respectively and are used as the motion information of the finger OB.

As the electronic apparatus 100 is capable of determining a position of the finger OB, the electronic apparatus 100 may track motion of the finger OB over time. In step 240, the processing unit may recognize a corresponding non-contact gesture to according to the motion information of the finger OB. In this embodiment, the processing unit may determine at least one of a direction of the movement and a distance of the movement of the finger OB in the predefined space coordinate system according to a relationship between the coordinates/positions of the finger OB and time.

For example, when determining that the finger OB moves from the position P_{H} (X_{H}, Y_{H}, Z_{H}) to a position P_{H}′ (X_{H}+k, Y_{H}, Z_{H}) at two adjacent points in time, the processing unit may recognize the non-contact gesture corresponding to the motion information of the finger OB as a shift gesture. To put it another way, as a motion vector of the finger OB in the predefined coordinate system equals (k, 0, 0) (which is parallel to the display screen 102), the motion information of the finger OB may be recognized as a left-to-right shift/swipe gesture. In one implementation, the horizontal shift movement of the finger OB may have a slight vertical shift, resulting in a motion vector (k, 0, Δz) of the finger OB. It should be noted that, as long as the value Oz is smaller than a predetermined offset (i.e. the direction of the movement of the finger OB is substantially parallel to the display screen 102), the processing unit may recognize the motion information of the finger OB as a shift gesture. In another implementation, the processing unit may recognize the motion information of the finger OB as a shift gesture if a horizontal shift distance (e.g. the aforementioned shift distance k) of the finger OB is greater than a predetermined distance.

In step 250, the processing unit may enable the electronic apparatus 100 to perform a specific function according to the recognized non-contact gesture. In this embodiment, an application shortcut icon AP of a picture taking function is displayed on the display screen 102, wherein a position of the application shortcut icon AP on the display screen 102 may be denoted by P_{A} (X_{A}, Y_{A}, 0). When the finger OB enters a sensing area of the electronic apparatus 100 (e.g. the finger OB enters a space above the display screen 102), the processing unit may start to track the motion of the finger OB (e.g. a cursor corresponding to the motion of the finger OB may be displayed on the display screen 102). When the processing unit detects that the finger OB stays above the application shortcut icon AP (e.g. a position (X_{A}, Y_{A}, Z_{H})) over a predetermined period of time (i.e. the finger OB is stationary over the predetermined period of time, or a period of time in which the distance of the movement of the finger OB is substantially zero is greater than the predetermined period of time), the processing unit may recognize a hold gesture and enable the electronic apparatus 100 to activate the picture taking function. In other words, the user may enable he electronic apparatus 100 to activate the picture taking function without touching the application shortcut icon AP displayed on the display screen 102.

Please note that the above is for illustrative purposes only, and is not meant to be a limitation of the present invention. In one implementation, the processing unit may obtain a motion vector directly according to the relationship between the coordinate of the finger OB and time, thereby recognizing a corresponding non-contact gesture. In another implementation, the processing unit may generate an image of the motion of the finger OB according to the motion information, thereby recognizing a corresponding non-contact gesture according to the image. In yet another implementation, the display screen 102 may be touch panel. Hence, the user may control the electronic apparatus 100 in a touch manner together with a non-contact manner. Additionally, an IR LED and a corresponding IR sensor may not be adjacent to each other. The number of the IR LEDS and the number of the corresponding IR sensors may not be the same. For example, as long as the IR LEDs IL1-IL3 are still activated alternately to emit signals, it is feasible to install only one IR sensor in the electronic apparatus 100. Further, the non-contact motion information of the finger OB may trigger a variety of specific functions.

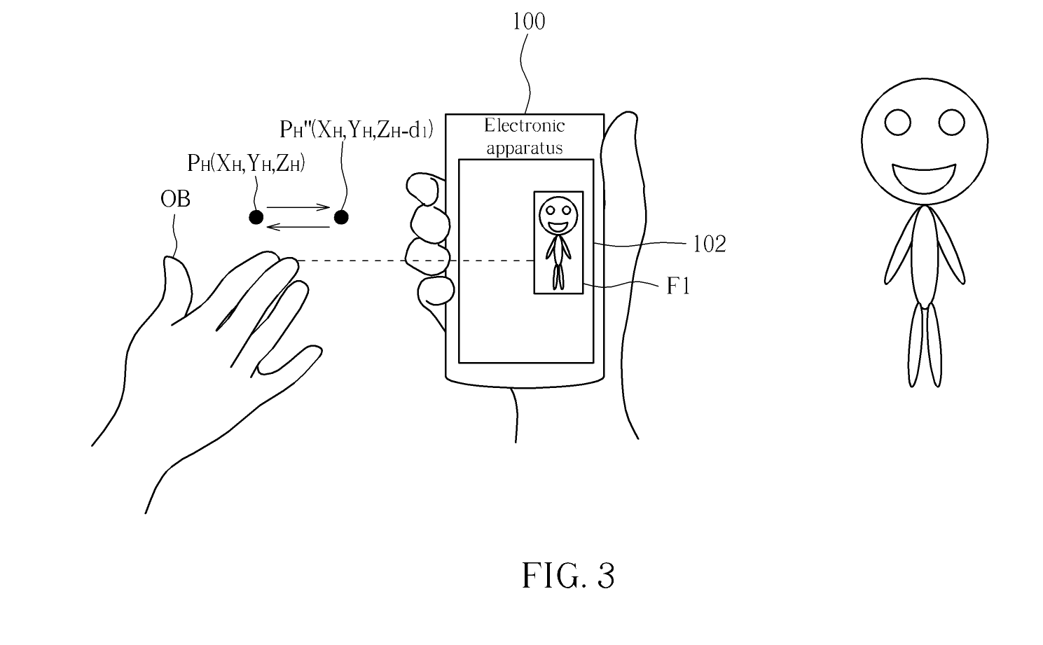

Please refer to FIG. 3, which is a first implementation of a non-contact control of the electronic apparatus 100 shown in FIG. to perform a specific function. In this implementation, the electronic apparatus 100 (e.g. a smart phone, a tablet computer or a camera) operates in a picture taking mode. When the finger OB enters a sensing area of the electronic apparatus 100 (e.g. the finger OB enters a space above the display screen 102, and a distance between the finger OB and the display screen 102 is not greater than a predetermined sensing distance), the processing unit may start to track the motion of the finger OB. For example, the a focus frame F1 corresponding to the motion of the finger OB may be displayed on the display screen 102, wherein the focus frame F1 may move in accordance with the motion of the finger OB above the display screen 102. In other words, a position of the focus frame F1 on the display screen 102 maybe substantially identical to a position of a projection of the finger OB onto the display screen 102 in the predefined space coordinate system. When the finger OB stays at a specific position above the display screen 102 (e.g. the position P_{H} (X_{H}, Y_{H}, Z_{H})) over a predetermined period of time so that the focus frame F1 stays at a face image displayed on the display screen 102 over the predetermined period of time, the processing unit may enable the electronic apparatus 100 to perform a focus function (i.e. a non-contact focus function).

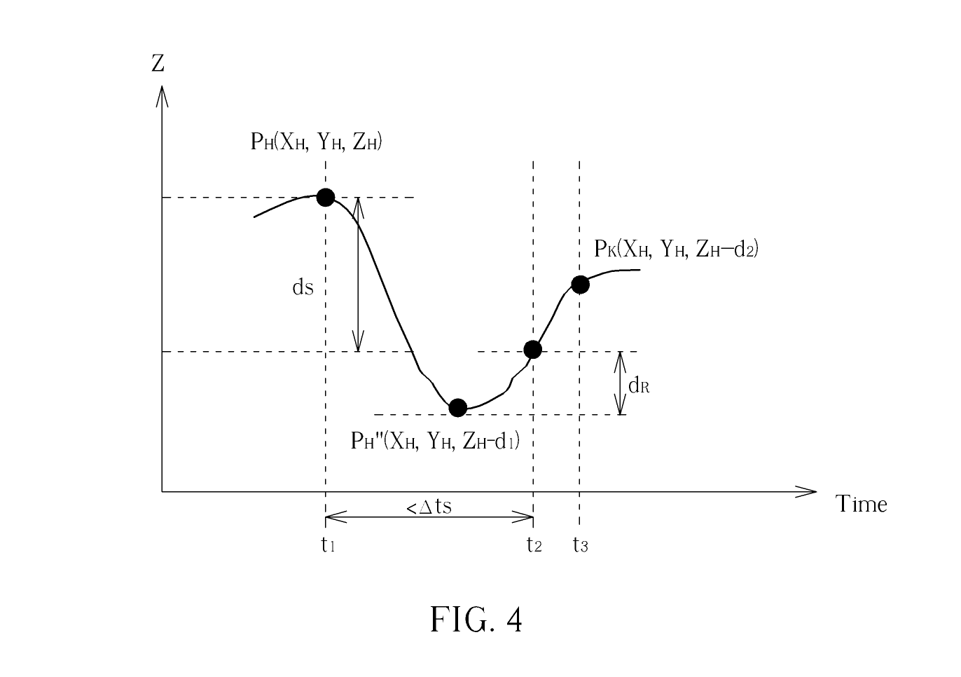

Additionally, the electronic apparatus 100 may perform a non-contact picture taking function. For example, after using a hold gesture to enable the electronic apparatus 100 to perform the non-contact focus function, the user may tap once the display screen 102 to enable the electronic apparatus 100 to perform a picture taking function. Please refer to FIG. 3 and FIG. 4 together. FIG. 4 is a diagram illustrating a relationship between a position of a non-contact object and time involved in a non-contact single tap gesture according to an embodiment of the present invention. In this embodiment, the finger OB moves over a predetermined distance dₛ from a specific position (i.e. the position P_{H}(X_{H}, Y_{H}, Z_{H}) at time t₁) to a specific position (i.e. a position P_{H}″ (X_{H}, Y_{H}, Z_{H}-d₁)) in a vertical direction toward the display screen 102, moves over a predetermined distance d_{R} (i.e. at time t₂) in a vertical direction away from the display screen 102, and arrives at a position P_{K} (X_{H}, Y_{H}, Z_{H}-d₂) at time t₃, wherein a time difference between time t₂ and time t₁ is shorter than a predetermined period time Δtₛ. The processing unit may recognize the motion of the finger OB as a single tap gesture (i.e. the finger OB tap the face image once) and enables the electronic apparatus 100 to take a picture of an image displayed on the display screen 102. In this implementation, the predetermined distance d_{R} may be shorter than the predetermined distance dₛ.

In one implementation, the processing unit may determine whether a displacement of the finger OB is greater than the predetermined distance dₛ/d_{R} according to a reflected energy of a reflected signal. Assume that a reflected energy corresponding to the finger OB at a first position (e.g. the position P_{H} (X_{H}, Y_{H}, Z_{H})) is a first sensing count. While the finger OB is moving toward the display screen 102 to a second position (e.g. the position P_{H}″ (X_{H}, Y_{H}, Z_{H}-d₁)) so that a difference between the first sensing count and a reflected energy corresponding to the finger OB at the second position (e.g. a second sensing count) is greater than a predetermined ratio of the first sensing count, the processing unit may determine that the displacement of the finger OB is greater than a predetermined distance (e.g. the predetermined distance dₛ). Similarly, while the finger OB is moving away from the display screen 102 (e.g. moving from the position P_{H}″ (X_{H}, Y_{H}, Z_{H}-dₗ) to the position P_{K} (X_{H}, Y_{H}, Z_{H}-d₂)), the processing unit may determine whether the finger OB moves over another predetermined distance according to another predetermined ratio. For example, the processing unit may determine that a difference between a sensing count corresponding to the finger OB at the position P_{H}″ (X_{H}, Y_{H}, Z_{H}-d₁) and a sensing count corresponding to the finger OB at the position P_{K} (X_{H}, Y_{H}, Z_{H}-d₂) is greater than the another predetermined ratio of a sensing count corresponding to the finger OB at the position P_{H}″ (X_{H}, Y_{H}, Z_{H}-d₁), thereby determining that the finger OB moves over the predetermined distance d_{R}. It should be noted that the predetermined ratio and the another predetermined ratio may be set based on actual designs/requirements, wherein the predetermined ratio and the another predetermined ratio may be the same or different.

In view of above, the user may activate the focus function according to different environments without touching the electronic apparatus 100 and activate the picture taking function without touching the electronic apparatus 100, thus avoiding hand shaking and touching the display screen 102 with oily hands.

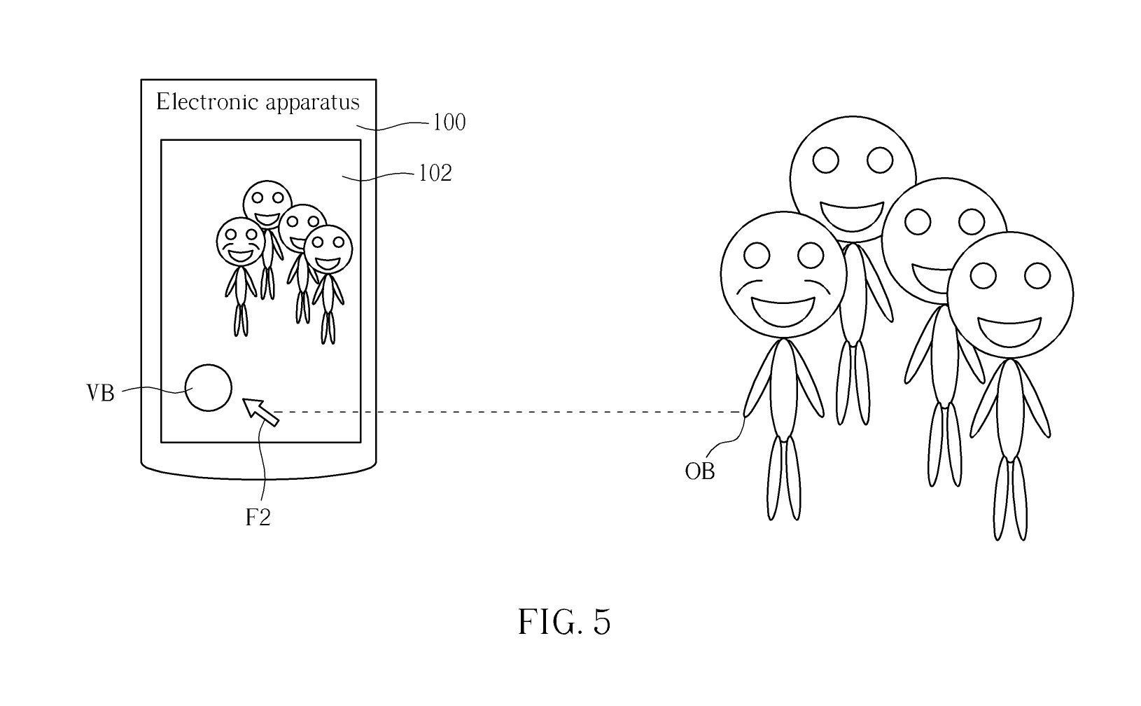

Please refer to FIG. 5, which is a second implementation of a non-contact control of the electronic apparatus 100 shown in FIG. 1 to perform a specific function. In this implementation, the electronic apparatus 100 operates in a picture taking mode. Similarly, when the finger OB enters a sensing area of the electronic apparatus 100, a selection symbol (or a selection frame) F2 corresponding to the motion of the finger OB may be displayed on the display screen 102, wherein the selection symbol F2 may move in accordance with the motion of the finger OB above the display screen 102. When the selection symbol F2 points to a specific object (e.g. a virtual button VB) displayed on the display screen 102, the user may tap once the virtual button VB contactlessly to activate the picture taking function.

In a case where the electronic apparatus 100 has the ability to detect a distant object, everyone (including a photographer) may be photographed based on the aforementioned non-contact picture taking mechanism. In one implementation, reflected energies of the IR LEDs IL1-IL3 shown in FIG. 1 may be increased. Hence, the corresponding IR sensors IS1-IS3 may receive reflected signals reflected from a distant object (e.g. a user's finger located several meters from the electronic apparatus 100), thereby recognizing a corresponding gesture according to the motion information of the distant object. In another implementation, the number of the IR LEDs shown in FIG. 1 may increase instead of the reflected energies of the IR LEDs. For example, the number of the IR LEDs corresponding to each IR sensor shown in FIG. 1 may be increased to three, and a reflected signal received by each IR sensor corresponds to an IR light signal emitted by the corresponding three IR LEDs. Hence, the reflected energy received by each IR sensor will not decrease even though the non-contact object is distant. In yet another implementation, the objective of detecting a distant object may be achieved by increasing detection time (e.g. integration time) of a reflected signal received by each IR sensor shown in FIG. 1.

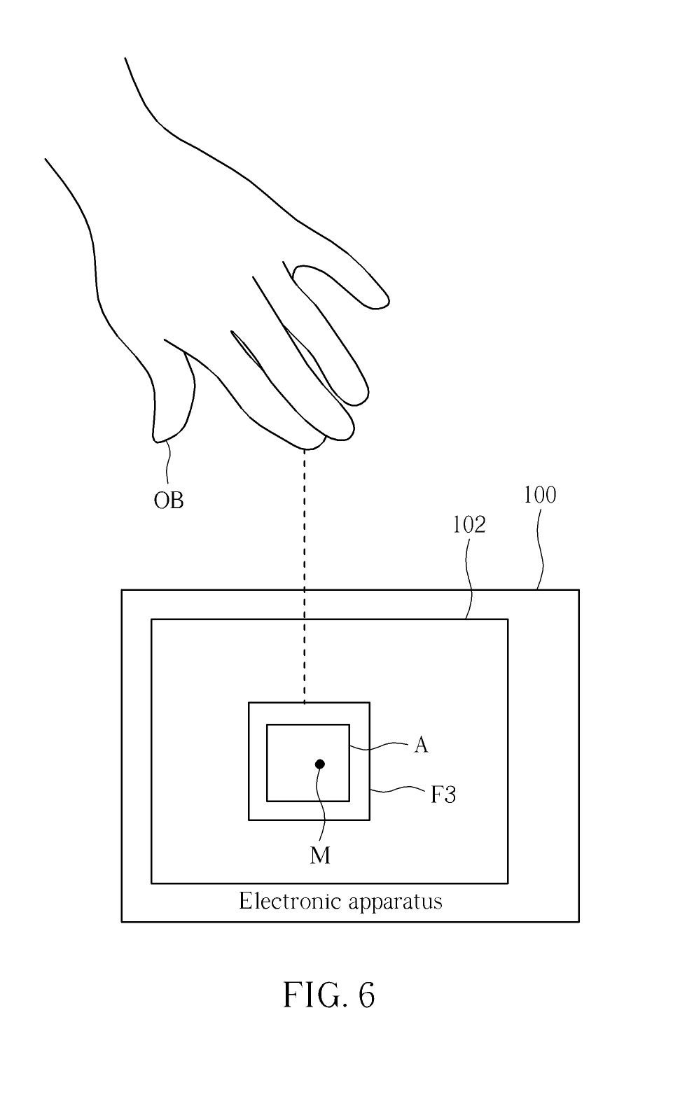

Please refer to FIG. 6, which is a third implementation of a non-contact control of the electronic apparatus 100 shown in FIG. 1 to perform a specific function. In this implementation, the electronic apparatus 100 operates in a map query mode. Similarly, when the finger OB enters a sensing area of the electronic apparatus 100, a selection frame (or a selection symbol) F3 corresponding to the motion of the finger OB may be displayed on the display screen 102, wherein the selection frame F3 may move in accordance with the motion of the finger OB above the display screen 102. When the selection frame F3 moves to an area of interest A displayed on the display screen 102 (i.e. the finger OB moves above the area of interest A), the user's finger OB may approach the display screen 102 (or approach the display screen 102 over a predetermined distance) to activate a zoom-in function. Specifically, when the processing unit of the electronic apparatus 100 determines that the finger OB moves over the predetermined distance in a vertical direction toward the display screen 102 (i.e. the finger OB approaches the display screen 102), the processing unit may recognize the motion information of the finger OB as an approaching gesture, thereby enabling the electronic apparatus 100 to zoom in an image of the area of interest A.

When the user wants to search another area, the user's finger OB may move away from the display screen 102 first (or move away from the display screen 102 over a predetermined distance) to enable the display screen 102 to display the previous image. In other words, when the processing unit determines that the finger OB moves over the predetermined distance in a vertical direction away from the display screen 102 (i.e. the finger OB moves away from the display screen 102), the processing unit may recognize the motion information of the finger OB as a receding gesture, thereby enabling the electronic apparatus 100 to zoom out an image currently displayed on the display screen 102.

In this implementation, the user's hand or finger needs not touch the display screen 102. Hence, the image displayed on the display screen 102 will not be hidden by hand(s) during a zoom-in/zoom-out operation. Additionally, when the user wants to tap a landmark M in the area of interest A to obtain related information, the user may tap icons near the landmark M unintentionally as an image of the landmark M is too small. The user may use the aforementioned approaching gesture to zoom in the area of interest A so that the landmark M may be selected (e.g. using a single tap gesture) correctly.

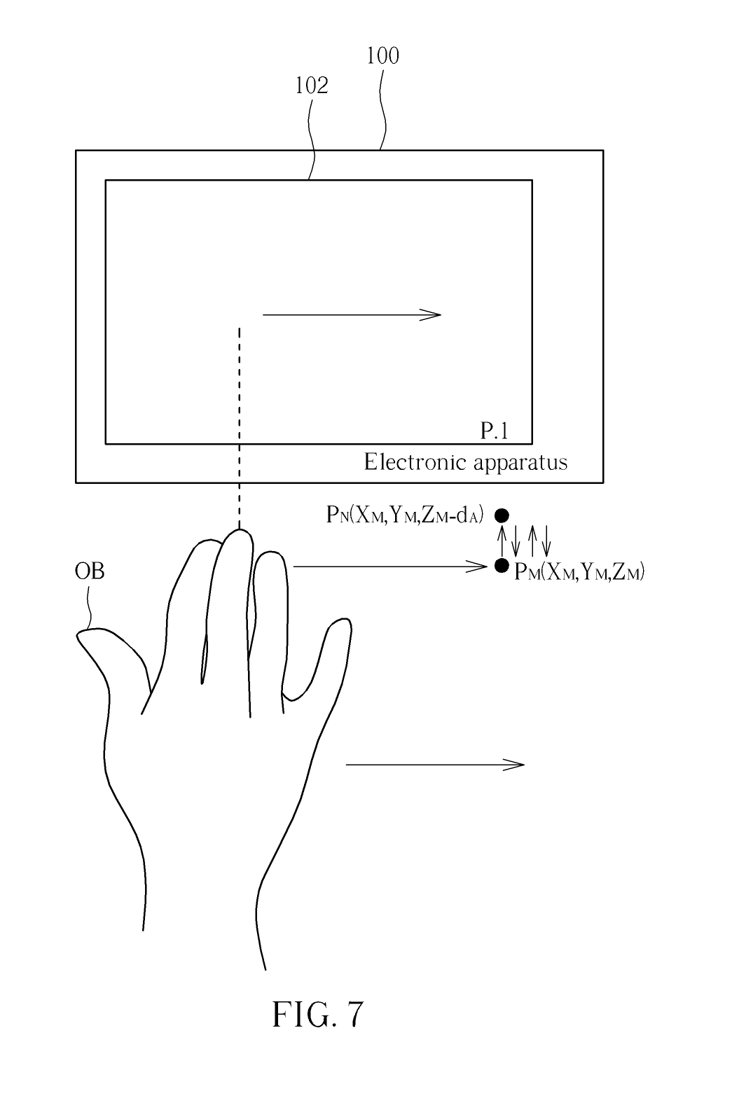

Please refer to FIG. 7, which is a fourth implementation of a non-contact control of the electronic apparatus 100 shown in FIG. to perform a specific function. In this implementation, the electronic apparatus 100 operates in an electronic book (e-book) reading mode. When the user has read the current page (e.g. page 1 ‘P.1’) and wants to read a next page, the user may move the finger OB to a sensing area of the electronic apparatus 100 and use the shift gesture (e.g. the finger OB moves from left to right over a predetermined distance in a direction parallel to the display screen 102) to thereby turn pages of the e-book from left to right, wherein the speed of page turning may depend on the moving speed of the finger OB. For example, high, normal and low speeds may correspond to tuning pages continuously, turning several pages and turning a single page, respectively. Additionally, when turning the pages of the e-book continuously (e.g. enabled by a high speed waving hand), the user may touch the display screen 102 with finger (s) to stop page turning.

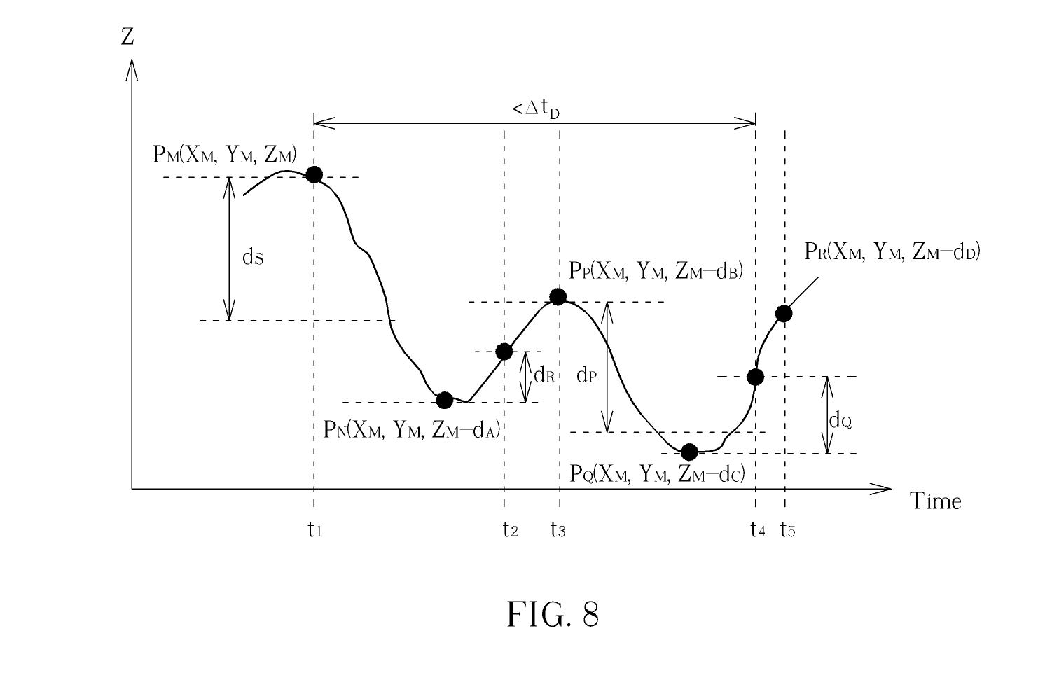

Further, when the user wants to stop turning pages, the user may tap the display screen 102 twice to enable the electronic apparatus 100 to perform a page-turning stopping function. Please refer to FIG. 7 and FIG. 8 together. FIG. 8 is a diagram illustrating a relationship between a position of a non-contact object and time involved in a non-contact double tap gesture according to an embodiment of the present invention. In this embodiment, the finger OB moves over a predetermined distance dₛ from a specific position (i.e. the position P_{M} (X_{M}, Y_{M}, Z_{M}) at time t₁) to a specific position (i.e. a position P_{N} (X_{M}, Y_{M}, Z_{M}-d_{A})) in a vertical direction toward the display screen 102, moves over a predetermined distance d_{R} (i.e. at time t₂) in a vertical direction away from the display screen 102, and arrives at a position P_{P} (X_{M}, Y_{M}, Z_{M}-d_{B}) at time t₃. Next, the finger OB moves over a predetermined distance d_{P} from the position P_{P} (X_{H}, Y_{H}, Z_{H}-d_{B}) to a position P_{Q} (X_{M}, Y_{M}, Z_{M}-d_{C}) in a vertical direction toward the display screen 102, moves over a predetermined distance d_{Q} (i.e. at time t₄) in a vertical direction away from the display screen 102, and arrives at a position P_{R} (X_{M}, Y_{M}, Z_{M}-dₙ) at time t₅, wherein a time difference between time t₄ and time t₁ is shorter than a predetermined period time Δt_{D}. The processing unit of the electronic apparatus 100 may recognize the motion of the finger OB as a double tap gesture (i.e. the finger OB tap the face image twice) and enables the electronic apparatus 100 to stop turning pages. Please note that the predetermined distances d_{S}, d_{R}, d_{P} and d_{Q} may be set according to actual requirements. For example, the predetermined distance dp may or may not equal the predetermined distance d_{S}. In addition, the processing unit may determine whether the displacement of the finger OB is greater than the predetermined distance d_{S}/d_{R}/d_{P}/d_{Q} according to a reflected energy of a reflected signal.

Please note that the aforementioned correspondence between the non-contact gesture and the specific function performed by the electronic apparatus is for illustrative purposes only, and is not meant to be a limitation of the present invention. For example, the focus function shown in FIG. 3 may be activated by another non-contact gesture (e.g. one of the approaching gesture, the receding gesture, the single tap gesture and the double tap gesture), the picture taking function shown in FIG. 3/FIG. 5 may be activated by another non-contact gesture (e.g. one of the hold gesture, the approaching gesture, the receding gesture and the double tap gesture), the zoom-in function shown in FIG. 6 may be activated by another non-contact gesture (e.g. one of the hold gesture, the receding gesture, the single tap gesture and the double tap gesture), the zoom-out function shown in FIG. 6 may be activated by another non-contact gesture (e.g. one of the hold gesture, the approaching gesture, the single tap gesture and the double tap gesture), and/or the page-turning stopping function shown in FIG. 7 may be activated by another non-contact gesture (e.g. one of the hold gesture, the approaching gesture, the receding gesture and the single tap gesture)

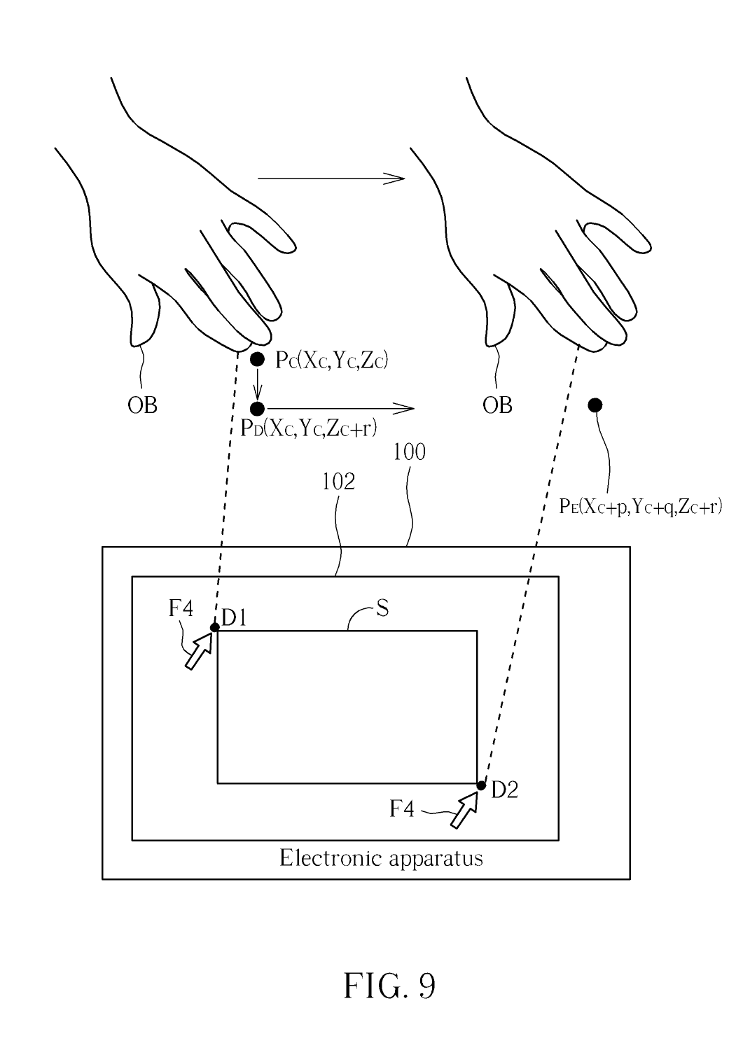

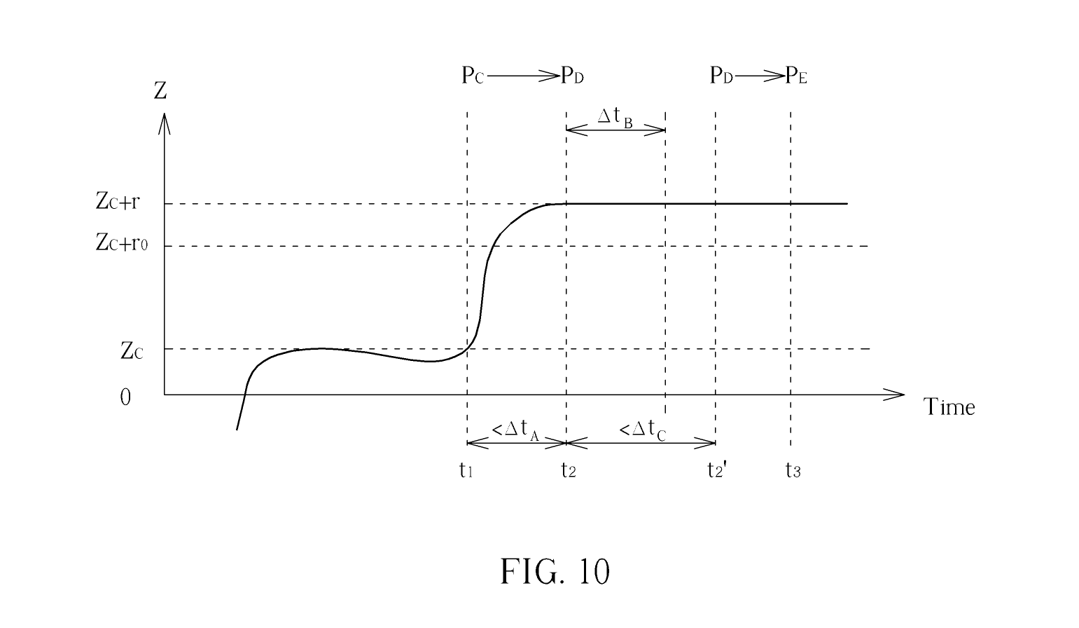

Based on the motion information of the non-contact object, a combination gesture formed by a plurality of non-contact gestures may be recognized to enable the electronic apparatus to perform a specific function. Please refer to FIG. 9 and FIG. 10 together. FIG. 9 is a fifth implementation of a non-contact control of the electronic apparatus 100 shown in FIG. 1 to perform a specific function, and FIG. 10 is a diagram illustrating a relationship between a position of a non-contact object and time involved in a non-contact drag gesture according to an embodiment of the present invention. In this implementation, the electronic apparatus 100 operates in a document editing mode. The user may use a combination gesture formed by a drag gesture and a hold gesture to select a specific range S of a document displayed on the display screen 102. Similarly, when the finger OB enters a sensing area of the electronic apparatus 100, a selection symbol F4 corresponding to the motion of the finger OB may be displayed on the display screen 102, wherein the selection symbol F4 may move in accordance with the motion of the finger OB above the display screen 102.

As shown in FIG. 9 and FIG. 10, the finger OB may move over a first predetermined distance r₀ from a first specific position (i.e. a position P_{c}(X_{c}, Y_{c}, Z_{c}) at time t₁) to a second specific position (i.e. a position P_{D} (X_{c}, Y_{c}, Z_{c}+r) at time t₂) in a vertical direction toward the display screen 102 during a firs predetermined period of time Δt_{A}. Next, the finger OB may stay at the position P_{D} (X_{c}, Y_{c}, Z_{c}+r) over a second predetermined period of time Δt_{B}, and move over a second predetermined distance from the position P_{D} (X_{c}, Y_{c}, Z_{c}+r) (i.e. time t₂′) to a third specific position (i.e. a position P_{E} (X_{c}+p, Y_{c}+q, Z_{c}+r)) in a direction parallel to the display screen 102 during a third predetermined period of time Δt_{c} after staying at the position P_{D} (X_{c}, Y_{c}, Z_{c}+r). The processing unit of the electronic apparatus 100 may recognize the motion information of the finger OB as a drag gesture, and enable the electronic apparatus 100 to select the specific range S of the document displayed on the display screen 102. At time t₃, the user may use the aforementioned hold gesture (not shown in FIG. 9) to complete the operation of range selection. Please note that, the selection symbol F4 may move from a position D1 (at time t₂′) to a position D2 displayed on the display screen 102 in response to the motion of the finger OB. Further, the predetermined distance r₀ may be set as a predetermined ratio of a distance between the first specific position (i.e. Z_{c}) and the display screen 102.

In this implementation, a star point of the specific rage S is the position D1, which corresponds to the position P_{D} (X_{c}, Y_{c}, Z_{c}+r) (where the finger OB moves toward and stays), and an end point of the specific rage S is the position D2, which corresponds to the position P_{E} (X_{c}+p, Y_{c}+q, Z_{c}+r) (where the finger OB stays finally), wherein the specific rage S may be defined as a range corresponding to a line connecting the start point and the end point mentioned above. For example, the specific rage S may be defined as a rectangular range corresponding to a diagonal line connecting the start point and the end point. In an alternative design, the position D1 and the position D2 may be located at the same row or the same column. Hence, the selected specific ranged may be a line connecting the start point and the end point.

In an alternative design, the processing unit of the electronic apparatus 100 may complete a range selection operation and a copy operation. In other words, the processing unit may select and copy the specific range S according to the combination gesture formed by the drag gesture and the hold gesture. In another alternative design, the combination gesture formed by the drag gesture and the hold gesture may be replaced by a combination gesture formed by two consecutive non-contact gestures, wherein a time interval between the two consecutive non-contact gestures may be shorter than a predetermined period of time. For example, the combination gesture formed by the drag gesture and the hold gesture may be replaced by a combination gesture formed by a drag gesture and a receding gesture, a combination gesture formed by a drag gesture and a single tap gesture, or a combination gesture formed by a single tap gesture and a shift gesture.

In another alternative design, the user may use a combination gesture formed by a single tap, a shift gesture and a specific gesture to activate the aforementioned range selection function and/or range selection and copy operation, wherein a time interval between the single tap gesture and the shift gesture may be shorter than a predetermined period of time, and a time interval between the shift gesture and the specific gesture may be shorter than another predetermined period of time. In other words, the combination of the single tap gesture and the shift gesture may replace the drag gesture shown in FIG. 9. Further, the specific gesture may be one of a receding gesture, a hold gesture and a single tap gesture.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method of an electronic apparatus, comprising:
generating a plurality of detection signals to a non-contact object around the electronic apparatus;
receiving a plurality of reflected signals reflected from the non-contact object in response to the detection signals, and accordingly generating a plurality of detection results;
performing arithmetic operations upon the detection results to calculate motion information of the non-contact object around the electronic apparatus;
recognizing a non-contact gesture corresponding to the non-contact object according to the motion information; and
enabling the electronic apparatus to perform a specific function according to the non-contact gesture.

2. The control method of claim 1, wherein a space surrounding the electronic apparatus corresponds to a predefined space coordinate system, and the step of performing the arithmetic operations upon the detection results to calculate the motion information of the non-contact object around the electronic apparatus comprises:
performing the arithmetic operations upon the detection results to calculate a plurality of coordinates of the non-contact object corresponding to different points in time in the predefined space coordinate system for use as the motion information.

3. The control method of claim 2, wherein the electronic apparatus defines a reference surface in the predefined space coordinate system, and the step of performing the arithmetic operations upon the detection results to calculate the coordinates of the non-contact object corresponding to different points in time in the predefined space coordinate system for use as the motion information comprises:
obtaining a plurality of sensing counts according to the detection results, and accordingly calculating a plurality of specific positions of the non-contact object corresponding to different points in time along a direction perpendicular to the reference surface, wherein the specific positions are used as the coordinates; and
determining whether a difference between a first sensing count corresponding to the non-contact object at a first specific position and a second sensing count corresponding to the non-contact object at a second specific position is greater than a predetermined ratio of the first sensing count;
wherein when it is determined that the difference is greater than the predetermined ratio of the first sensing count, the motion information further indicates that the non-contact object moves from the first specific position to the second specific position over a predetermined distance.

4. The control method of claim 2, wherein the step of recognizing the non-contact gesture corresponding to the non-contact object according to the motion information comprises:
determining at least one of a direction of movement and a distance of the movement of the non-contact object in the predefined space coordinate system according to a relationship between the coordinates and time.

5. The control method of claim 4, wherein when it is determined that the non-contact object is stationary over a predetermined period of time, the non-contact gesture is a hold gesture.

6. The control method of claim 5, wherein the step of enabling the electronic apparatus to perform the specific function according to the non-contact gesture comprises:
enabling the electronic apparatus to perform a focus function according to the hold gesture.

7. The control method of claim 4, wherein the electronic apparatus defines a reference surface in the predefined space coordinate system.

8. The control method of claim 7, wherein when it is determined that the non-contact object moves over a predetermined distance in a direction parallel to the reference surface, the non-contact gesture is a shift gesture.

9. The control method of claim 8, wherein the step of enabling the electronic apparatus to perform the specific function according to the non-contact gesture comprises:
enabling the electronic apparatus to perform a page turning function according to the shift gesture.

10. The control method of claim 7, wherein when it is determined that the non-contact object moves over a predetermined distance in a vertical direction toward the reference surface, the non-contact gesture is an approaching gesture.

11. The control method of claim 10, wherein the step of enabling the electronic apparatus to perform the specific function according to the non-contact gesture comprises:
enabling the electronic apparatus to perform a zoom-in function according to the approaching gesture.

12. The control method of claim 7, wherein when it is determined that the non-contact object moves over a predetermined distance in a vertical direction away from the reference surface, the non-contact gesture is a receding gesture.

13. The control method of claim 12, wherein the step of enabling the electronic apparatus to perform the specific function according to the non-contact gesture comprises:
enabling the electronic apparatus to perform a zoom-out function according to the receding gesture.

14. The control method of claim 7, wherein when it is determined that the non-contact object moves over a first predetermined distance from a first specific position to a second specific position in a vertical direction toward the reference surface during a firs predetermined period of time, stays at the second specific position over a second predetermined period of time, and moves over a second predetermined distance from the second specific position in a direction parallel to the reference surface during a third predetermined period of time after staying at the second specific position, the non-contact gesture is a drag gesture.

15. The control method of claim 7, wherein when it is determined that the non-contact object moves over a first predetermined distance from a specific position in a vertical direction toward the reference surface and moves over a second predetermined distance in a vertical direction away from the reference surface in sequence during a predetermined period of time, the non-contact gesture is a single tap gesture.

16. The control method of claim 15, wherein the first predetermined distance is greater than the second predetermined distance.

17. The control method of claim 15, wherein the step of enabling the electronic apparatus to perform the specific function according to the non-contact gesture comprises:
enabling the electronic apparatus to perform a picture taking function according to the single tap gesture.

18. The control method of claim 7, wherein when it is determined that the non-contact object moves over a first predetermined distance from a specific position in a vertical direction toward the reference surface, moves over a second predetermined distance in a vertical direction away from the reference surface, moves over a third predetermined distance in the vertical direction toward the reference surface, and moves over a fourth predetermined distance in the vertical direction away from the reference surface in sequence during a predetermined period of time, the non-contact gesture is a double tap gesture.

19. The control method of claim 18, wherein the step of enabling the electronic apparatus to perform the specific function according to the non-contact gesture comprises:
enabling the electronic apparatus to perform a page-turning stopping function according to the double tap gesture.

20. The control method of claim 7, wherein the reference surface is a display screen or a touch panel of the electronic apparatus.

21. The control method of claim 1, wherein when the non-contact gesture is a combination gesture formed by a single tap gesture, a shift gesture and a hold gesture, the specific function performed by the electronic apparatus is to select a specific range, or select and copy the specific range.
